(19) United States
(12) Patent Application Publication
(10) Pub. No.: US 2008/0219582 A1
(43) Pub. Date: Sep. 11, 2008

(54) Apparatus for Filtering an Image Obtained by Block Based Image Decompression

(75) Inventor: Ihor Olehovych Kirenko, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/064,638

(22) PCT Filed: Aug. 21, 2006
(86) PCT No.: PCT/IB2006/052879

§ 371 Date: Feb. 25, 2008

(30) Foreign Application Priority Data
Aug. 29, 2005 (EP) 05107873.1

(51) Int. Cl. G06K 9/62

(52) U.S. Cl. 382/261

(57) ABSTRACT

Block-wise compressed image data is decompressed and the decompressed data is subjected to a cascade of low pas filtering operations, in order to remove block edge artefacts and/or ringing artefacts. Selected ones of said low pass filtering operations in the cascade are skipped for selected pixel locations. The decision to skip is based on the size of the variation for the selected pixel location. An increasing number of filtering operations in the cascade is skipped with increasing size of the variations.

The invention relates to block based image decompression.

MPEG and JPEG are popular block-based image compression and decompression standards. For compression, the pixel locations in an image are grouped into rectangular blocks and for each block DCT (Digital Cosine Transform) coefficients of pixel values of the pixel location in the block are computed. The DCT coefficients are quantized, which results in compression of the image data. During decompression pixel values are recomputed from the quantized DCT coefficients by means of an inverse DCT.

This technique may lead to compression artefacts in the image, such as false step transitions at the boundaries between blocks in the decompressed image and “ringing” around sharp object edges in the image.

US patent application No. 2002/0126912 describes an MPEG image decompression technique wherein low pass filtering is applied to selected pixels of the decompressed image in order to reduce artefacts. Low pass filtering is suitable for removing, or at least reducing, compression artefacts like transitions and ringing. However, low pass filtering has the disadvantage that it can blur the original image content. To reduce blurring, US appl. No. 2002/0126912 uses a detection for each pixel to determine whether the location of the pixel is on a block boundary and not also on a natural edge in the image. A combination of a row based one dimensional low pass filter and a column based one-dimensional low pass filter is applied to the decompressed image for obtaining pixel values for the pixels that meet this condition. For the other pixels unfiltered decompressed pixel values are used.

US patent application No. 2003/147559 also describes a decompression technique wherein low pass filtering is applied to selected pixels. This document computes the maximal intensity difference between adjacent decompression blocks. When this intensity difference is below a threshold it is assumed that there is no object edge between the blocks and low pass filtering is applied to suppress artefacts.

It may be noted that both these documents use quite complicated and computation intensive detection techniques to decide whether or not filtering should be applied. This is necessary because the results of conditionally applying a low pass filter require a careful balance: over-zealousness in application of the filter degrades the image by needless blurring, laxity leaves visible decompression artefacts.

Among others, it is an object of the invention to provide for a method and apparatus wherein compression artefacts can be removed by conditional filtering with less sensitivity to complex criteria for filtering.

In aspect the invention provides for an apparatus according to claim 1. Herein a plurality of low-pass filtering operations are cascaded. A variable number of the low-pass filtering operations in the cascade can be skipped for selected pixel locations. Thus a more refined control over filtering is provided that makes it possible to use less complex criteria for deciding whether or not to apply respective filtering operations without strong effects on visible artefacts.

These and other objects and advantageous aspects will become apparent from a non-limitative description of the drawing.

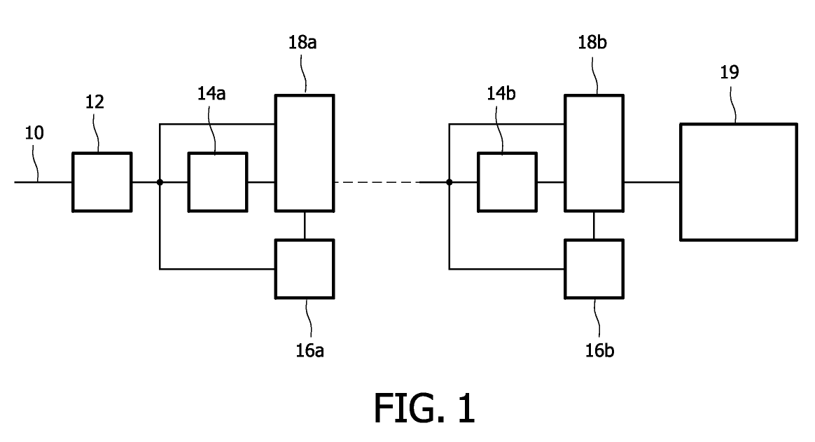

FIG. 1 shows a signal flow diagram,

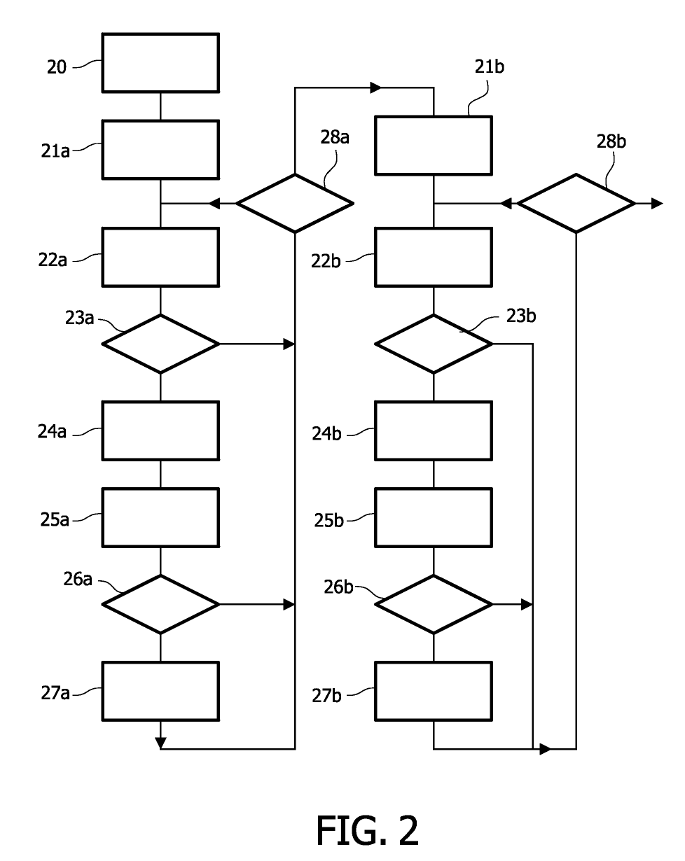

FIG. 2 shows a flow-chart.

FIG. 1 shows a signal flow diagram with an input 10, a decompression stage 12, a series of filter stages 14a-b, a series of test stages 16a-b, a series of selection stages 18a-b and an image rendering stage 19. Decompression stage 12 is coupled to input 10 to receive compressed data and to a first filter stage 14a to output decompressed data. A first selection stage 18a has respective signal inputs coupled to the output of decompressing stage 12 and first filter stage 14a. A first test stage 16a has an input coupled to the output of decompressing stage 12 and an output coupled to a control input of selection stage 18a.

A subsequent filter stage 14b, test stage 16b and selection stage 18b are similarly coupled as the first filter stage 14a, first test stage 16a and first selection stage 18a, except that their inputs are coupled to an output of a preceding selection stage 18a instead of to the output of decompression stage 12. Although only sets of a filter stage 14a-b, a test stage 16a-b and a selection stage 18a-b are shown, it should be appreciated that a larger number of such sets will typically be present, connected in cascade, that is, each with the inputs of its filter stage, a test stage and a selection stage coupled to the output of the selection stage of the preceding set. The output of the last selection stage 18b in the series is coupled to an input of rendering stage 19 which uses image data from the last selection stage 18b to control image display on a display screen that is part of rendering stage 19.

The signal flow diagram may be implemented in various ways. In one embodiment each stage is implemented with a respective circuit, for example a correspondingly programmed signal processing circuit, and the respective circuits are interconnect as shown in the Figure. In another embodiment different ones of the stages are implemented using the same signal processing circuit under control of different parts of a program. In this implementations connections between the stages are realized by storage of signal data in transfer storage elements such as processor registers.

In operation, during processing according to the signal flow diagram of FIG. 1, compressed image data is supplied to decompression stage 12 via input 10. Decompression stage 12 decompresses respective blocks, using for example MPEG or JPEG compatible decompression techniques (including inverse DCT computations). After a variable degree of filtering by the intermediated stages rendering stage 19 uses the result of filtering to control image display. The variable degree of filtering is realized by bypassing (skipping) a variable number of the filter stages 14a-b for selected pixel locations, each filter stage being skipped dependent on a different test result.

First test stage 16a tests for each of a series of pixel locations whether spreads in the pixel values in regions on mutually opposite sides of the pixel location are below a threshold and whether less than a threshold step occurs between the regions. If so, first test stage 16a controls first selection stage 18a to pass filtered data from first filter stage 14a to its output. If not first test stage 16a controls first selection stage 18a to pass unfiltered data from the input of first filter stage 14a to its output.

Next the output of first selection stage 18a is treated in the same way again, involving testing and conditional selection of filtered or unfiltered data. The filter operations of the successive filter stages are for example both one-dimensional low pass filter operations that smooth out pixel value variations along a an image row direction. Thus, two successive low pass filtering operations of this type are applied in the case of stronger steps occur and only one, or even no low pass filtering operation of this type are applied, dependent on the strength of the step in the pixel values between the opposite regions and the size of the spread in these regions. As will be appreciated more than two sets of stages may be used, so that an even more variable number of low-pass filtering operations of this type may be realized.

Furthermore, it will be appreciated that, in series with such a plurality of stages for conditional one dimensional low pass filtering along one image direction another plurality of stages may be provided for conditional one dimensional low pass filtering along another image direction (e.g. stages for filtering along rows of the image and stages for filtering along columns of the image). Also, although an embodiment has been shown wherein each stage receives input values only from a preceding stage, it should be appreciated that part of the input values of the test stage and/or filter stages could be obtained from earlier stages in the cascade of stages.

FIG. 2 illustrates a decompression process by means of a flow-chart. The steps of this flow-chart are performed by a processing circuit which may for example be a signal processor circuit that is programmed or otherwise configured to perform the process or by a general purpose computer programmed to do so, or by a combination of such circuits, wherein different circuits performs different steps.

At the start of the flow-chart the processing circuit executes a block-based decompression step 20 such as is used in MPEG or JPEG codecs, which results in an image (or part of an image) of pixel values. Decompression step 20 is followed by a first step 21a wherein the processing circuit selects a pair of initial pixel locations of a scan of pairs along successive lines of the decompressed image.

In a second step 22a the processing circuit computes numbers that are representative of the variation in pixel values around the selected pair of pixel locations. In one example a first spread A1 is computed among pixel values for three mutually adjacent pixel locations going left from the left pixel location of the selected pair, i.e. a difference between the maximum and the minimum pixel value for these pixel locations. In this example a similar, second spread A2 is computed among pixel values for three mutually adjacent pixel locations going right from the right pixel location of the selected pair. Furthermore in this example an absolute value D of the difference between the pixel value for the pixel locations of the pair is computed.

In a third step 23a the processing circuit uses the numbers that have been computed in second step 22a to decide whether or not to perform a first-stage filter operation for the selected pair. The first-stage filter operation is performed in a fourth step 24a. In the example the processing circuit compares the numbers A1 and A2 with a first threshold and the number D with a second threshold. If any of the numbers A1, A2 and D is above the corresponding threshold the processing circuit skips the first-stage filter operation for the selected pair. The filter operation in fourth step 24a involves for example computing filtered pixel values as weighted averages of the left and right pixel values in the pair:

left filtered value=(3*left pixel value+right pixel value)/4

right filtered value=(3*right pixel value+left pixel value)/4

In a fifth step 25a after the first-stage filter operation of fourth step 24a the processing circuit computes a new set of numbers that is representative of the spread after performing the first-stage filter operation. In one example, similar spreads as in second step 22a are computed, but from the filtered values for the pair of pixel locations instead of from the original pixel values. In a sixth step 26a the processing circuit uses the numbers that have been computed in fifth step 25a to decide whether or not to perform a second-stage filter operation for the selected pair. The second-stage filter operation is performed in a seventh step 27a. In an example a similar test may be used as in third step 23a, but with higher thresholds. The filter operation of seventh step 27a involves computing filtered pixel values as weighted averages from a wider range of pixel locations than in fourth step 24a, using the filtered values for the pair of pixels as input.

new left filtered value=(2*left filtered pixel value+right pixel value+Y1)/4

new right filtered value=(2*right filtered pixel value+left pixel value+Y2)/4

Herein Y1 and Y2 are the original pixel values for the pixel locations adjacent the left and right pixel location of the pair.

Subsequently, in an eight step 28a the processing circuit selects a new pair if possible and if so repeats the process from second step 22a. Typically, successive pairs along a line in the image are selected and once all pairs in a line have been processed pairs from a next line are selected and so on.

Once all pairs have been processed the processing circuit, the process is repeated along another image direction, selecting pairs of pixel locations along columns in the image instead of horizontal lines. Corresponding first to eight steps 21b-28b are performed that are similar to first to eight steps 21a-28a as described, except that instead of horizontally neighboring pixel locations neighboring pixel locations above and below the selected pair are used.

Preferably, the steps of the flow chart are performed at least for luminance pixel values in case of a color image. In addition similar steps may be performed for color components such as UV components. Alternative the steps may be performed for each of the RGB components of a color image. In one embodiment, for each stage one common test is performed to decide whether the filtering operations of the stage should be applied to all color/luminance components. Alternatively, separate tests may be performed for difference color/luminance components.

It should be appreciated that the flow chart merely shows an example of an embodiment. Various variations on the flow chart are possible. As one example, although the decompression step 20 has been shown as part of the process, it should be appreciated that it is not necessary that this step is executed in the same apparatus as the other steps. Decompression may be performed in one apparatus and filtering and testing in another apparatus.

As another example, although only four steps corresponding to filtering stages with corresponding tests for skipping these filtering stages have been shown, it should be realized that a greater number of filtering stages and tests may be used, or that filtering could be limited to one dimension (along a line or along a column) only. As another example, although it is shown that the process proceeds to eight step 28a,b (selection of a new pair if the decision in third step 23a,b is not to perform the first stage filtering step 24a,b) it should be appreciated that instead the process may proceed to fifth step 25a if the first stage filtering step 24a,b is skipped. In this case the second test and second-stage filtering operation use the original pixel values for the pair of pixel locations instead of the filtered values if the first-stage filtering operation has been skipped.

Furthermore, although the flow-chart shows an embodiment wherein subsequent tests and filtering operations 22a-27a are performed for a pair of pixel locations before a next pair is processed, it should be appreciated that instead a first part 22a-24a- of the steps may be performed for all pairs before the next part 25a-27a of the steps is performed. An advantage of processing both parts for each pair together is that less storage is required for intermediate filtered values. To facilitate one-cycle processing, the second stage filter operation uses a mix of filtered pixel values for the pixel locations in the pair and original pixel values for the pixel locations outside the pair as described. Use of original pixel values for locations outside the pair has the additional advantage that blurring is reduced. For this reason, in another embodiment original pixel values are used even if separate cycles are used for the different stages of filtering.

Also, instead of computing filtered values for pairs of pixel locations together in one cycle through the steps, a filtered value for one pixel location may be computed in each cycle. Using a pair in each cycle has the advantage that only one set of tests has to be performed for each pair, instead of one set of tests for each pixel location of the pair.

Furthermore, although specific examples of tests have been given to decide whether or not to perform a filtering operation at a certain stage, it should be appreciated that other tests could be used. In one embodiment, a mix of luminance and color components is used to decide whether or not to perform a first or second stage filtering, skipping filtering for example if the step size in at least one color component from one pixel location of the pair to the other is above a threshold.

Also, although line (row) and column based tests and filtering operations have been shown, wherein filtered values and testing depend only on pixel values from the same line (or column) as the pair of pixel locations, it should be realized that instead pixel values for locations from regions that extend in more dimensions may be used for the tests and/or for filtering, e.g. from two dimensional regions to the left and right of the pixel locations of the pair and/or, in the case of a video sequence from previous and/or subsequent images.

It may be noted that the examples of the test used in the flow-chart test for the absence of more than threshold amounts of spread in pixel values for pixel locations left and right of a pair of pixel locations and the absence of a step between the pixel values for the pixel locations of the pair. This is based on the assumption that a large step is indicative of a visible “real” edge that should not be filtered. The presence of spread left or right of the pair of pixel locations is taken to be indicative of the presence of textured image areas or strong edges that would make an artefact edge between the pixel values of the pair invisible and/or that may indicate that the edge between the pixel values of the pair itself is part of a texture and should therefore not be filtered.

Simple tests are used, involving only local pixel values, preferably only along a (horizontal) line or (vertical) column. The effect of these tests is limited by applying at least the less stringent tests, such as in sixth step 26a,b, only to skipping of individual stages (steps 27a,b) in a multi-stage filtering process, wherein increased blurring is the effect of the accumulation of filtering operations. However, other tests than those of the example may be used.

For example, instead of testing spread among three pixels location s to the left and right a larger or smaller number than three pixel locations may be used. Also the degree to which variations in pixel values contribute to the computed spread may be made a decreasing (or at least non-increasing) function of distance from the pair. Use of a larger number yields a more reliable result, but too large a number entails the risk that far-off spread that will not make an artefact invisible. Use of a smaller number increases the risk that low-pass filtering will be applied too often, which would result in needless blurring. Use of three pixel locations on either side has been found to be a good compromise.

Instead of a difference between maxima and minima a different measure of spread such as a root mean square value or an average size of a deviation from an average may be used. Also additional conditions may be added that must also be satisfied to prevent skipping, such as conditions that a size of a difference between adjacent pixels in the regions on both sides of the pair is below a further threshold. This complicates processing but prevents needless blurring near strong edges. In another embodiment, an overall measure of spread in a region left and right of the pixel locations may be compared with a threshold to skip a filter stage if the overall spread exceeds a threshold. However, the comparison of separate measures with respective thresholds has the advantage that different thresholds may be used for spread in neighboring regions and for the size of the step in the pixel values of the selected pair of pixel locations. Thus for example a small spread and a larger step size may be used as threshold for skipping a filtering stage. As a result, reduction of relatively large artefact edges by executing a filtering stage can be made conditional on the presence of no more than a relatively weak texture. It will be appreciated that the spreads on respective sides of the pair need not be tested separately. For example the spreads on either sides of the pair may be combined into a common measure of spread (e.g. a maximum of the spreads on either side, or a sum) before comparison with a threshold.

Preferably, the conditional execution of filtering operation is applied to substantially all pixel locations in an image (possibly excepting pixel location near borders of the image), or to pairs of pixel locations. Alternatively, the testing and application of filter stages may be limited to pairs of pixel locations that lie on mutually opposite sides of boundaries between decompression blocks. In this way, the risk is reduced that real image edges are suppressed or blurred that are not due to block artefacts. Application of testing to decide on the application of respective filter stages, however is less complex since no information about block boundaries needs to be supplied from a decompression apparatus for example. Moreover, in this way ringing artefacts that do not lie on block boundaries can be filtered out as well.

The invention can be applied for example in any image handling apparatus that uses block based decompression, such as in television sets prior to rendering static images or video images, decoder apparatuses that are coupled in series with a television sets, digital camera's, mobile telephone that are provided with a display screen etc., and integrated circuits for use in such a television set, decoder etc.

1. An image handling apparatus for handling block-wise compressed image data, the apparatus comprising an input for receiving a decompressed image, a filtering circuit (14a-b, 16a-b, 18a-b) coupled to the input and arranged to perform at least two spatial filtering operations at least partly in cascade with each other on the block-wise decompressed image data, each of the filtering operations effecting low-pass filtering at least along a same common image direction, the filtering circuit (14a-b, 16a-b, 18a-b) being arranged to perform tests of pixel location dependent variation in pixel values determined by the decompressed image data, and to locally skip selected ones of said low pass filtering operations for selected pixel locations in the cascade, each selected one of said low pass filtering operations being locally skipped dependent on whether a respective one of the test detects that the variation for the selected pixel location exceeds a respective minimum criterion.

2. An image handling apparatus according to claim 1, arranged to perform, as part of the tests for at least one of the low pass filtering operation, a first comparison of a first threshold with a size of a difference between pixel values of the selected pixel location and a neighboring pixel location of the selected pixel location and one or more second comparisons of a second threshold with spreads, or a combined spread, among pixel values of pixel locations in regions extending in mutually opposite directions from the selected pixel location and the neighboring location respectively, the at least one of the low pass filtering operation being skipped if said size and/or said spread or spreads exceed the first and second threshold respectively.

3. An image handling apparatus according to claim 2, wherein each of the regions comprises at least three pixel locations.

4. An image handling apparatus according to claim 2, wherein each of the regions comprises no more than three pixel locations.

5. An image handling apparatus according to claim 1, wherein different ones of the low pass filtering operations comprise a first one dimensional filtering operation and a second one dimensional filtering operation respectively, both along said common image direction.

6. An image handling apparatus according to claim 1, wherein the filtering circuit (14a-b, 16a-b, 18a-b) is arranged to perform a common test for a pair of neighboring pixel locations, the common test testing for a size of a difference between pixel values for the pair of locations and/or pixel location dependent spread determined by the decompressed image data in regions extending in mutually opposite directions from the selected pixel location and the neighboring location respectively, and to skip a selected one of the low pass filtering operations in the cascade for both locations of the pair on the basis of said common test.

7. An image handling apparatus according to claim 6, wherein the low pass filtering operations comprise a further low pass filtering operation that follows the selected one of the low pass filtering operations in the cascade, the further low pass filtering operation having as inputs input values of said selected one of the low pass filtering operations for pixel locations on mutually opposite sides of said pair and filtered pixel values produced by said selected one of the low pass filtering operations for said pair if the selected one of the low pass filtering operations is not skipped.

8. A method of decompressing block-wise compressed image data, the method comprising:
performing at least two spatial filtering operations at least partly in cascade on block-wise decompressed image data, each of the filtering operations effecting low-pass filtering at least along a same common image direction,
performing tests of pixel location dependent variation in pixel values determined by the decompressed image data,
skipping selected ones of said low pass filtering operations in the cascade for selected pixel locations, each selected one of said low pass filtering operations being skipped dependent on whether a respective one of the test detects that the variation for the selected pixel location exceeds a respective minimum criterion.

9. A method according to claim 9, comprising, as part of performing the tests for at least one of the low pass filtering operation, performing:
a first comparison of a first threshold with a size of a difference between pixel values of the selected pixel location and a neighboring pixel location of the selected pixel location and,
one or more second comparisons of a second threshold with spreads, or a combined spread, among pixel values of pixel locations in regions extending in mutually opposite directions from the selected pixel location and the neighboring location respectively,
the at least one of the low pass filtering operation being skipped if said size and/or said spread or spreads exceed the first and second threshold respectively.

10. A method according to claim 9, wherein different ones of the low pass filtering operations comprise a first one dimensional filtering operation and a second one dimensional filtering operation respectively, both along a said common image direction.

11. A method according to claim 9, comprising:
performing a common test for a pair of neighboring pixel locations, testing for a size of a difference between pixel values for the pair of locations and/or pixel location dependent spread determined by the decompressed image data in regions extending in mutually opposite directions from the selected pixel location and the neighboring location respectively,
skipping a selected one of the low pass filtering operations in the cascade for both locations of a pair on the basis of said common test.

12. A method according to claim 11, wherein the low pass filtering operations comprise a further low pass filtering operation that follows the selected one of the low pass filtering operations in the cascade, the further low pass filtering operation having as inputs input values of said selected one of the low pass filtering operations for pixel locations on mutually opposite sides of said pair and filtered pixel values produced by said selected one of the low pass filtering operations for said pair if the selected one of the low pass filtering operations is not skipped.

13. A computer program product comprising a program with instructions which, when executed by a programmable processing circuit, cause the programmable processing circuit to:
perform at least two spatial filtering operations at least partly in cascade on block-wise decompressed image data, each of the filtering operations effecting low-pass filtering at least along a common image direction,
perform tests of pixel location dependent variation in pixel values determined by the decompressed image data,
skip selected ones of said low pass filtering operations in the cascade for selected pixel locations, each selected one of said low pass filtering operations being skipped dependent on whether a respective one of the test detects that the variation for the selected pixel location exceeds a respective minimum criterion.
